(19) United States
(12) Patent Application Publication
(10) Pub. No.: US 2004/0160949 A1
(43) Pub. Date: Aug. 19, 2004

(54) Apparatus and method for transmitting voice data on ADSL subscriber Board

(76) Inventors: Yong-Ki Kim, Suwon-city (KR); Hye-Won Kang, Uijongbu-city (KR)

Correspondence Address: Robert E. Bushnell, Suite 300, 1522 K Street, N.W., Washington, DC, 20005-1202, US

(21) Appl. No.: 10/756,680

(22) Filed: Jan. 14, 2004

(30) Foreign Application Priority Data
Feb. 19, 2003 (KR) 10-2003-10507

(51) Int. Cl. H04L 12/66

(52) U.S. Cl. 370/352; 370/493

(57) ABSTRACT

An apparatus for transmitting voice data on a Next Generation Network Asymmetric Digital Subscriber Line (ADSL) subscriber board and a method thereof enable a Channelized Voice over xDSL (CVoDSL) function as a voice service function of an ADSL subscriber, stable signaling of the CVoDSL, and synchronization of an ADSL subscriber board and a Public Switched Telephone Network (PSTN) to embody the CVoDSL function. The service to the voice subscriber using an ADSL line can be maintained with the same voice quality as that of an existing copper cable subscriber and the same service can be carried out with less expensive equipment. Also, the need for a splitter to provide services using a separate voice band frequency on the ADSL line can be eliminated, and a plurality of users can be provided with voice services by sharing and dividing a service frequency band on the same line.

### CLAIM OF PRIORITY

This application makes reference to, incorporates the same herein, and claims all benefits accruing under 35 U.S.C. §119 from my application APPARATUS AND METHOD FOR TRANSMITTING VOICE DATA ON ADSL SUBSCRIBER BOARD filed with the Korean Industrial Property Office on Feb. 19, 2003 and there duly assigned Ser. No.2003-10507.

### BACKGROUND OF THE INVENTION

1. Technical Field

The present invention generally relates to an apparatus for transmitting voice data on an Asymmetric Digital Subscriber Line (referred to as an ADSL, hereinafter) subscriber board and a method thereof and, more particularly, to an apparatus for transmitting voice data on an ADSL subscriber board using a Next Generation Network (referred to as an NGN, hereinafter) and a method thereof.

2. Related Art

In general, the rapidly changing communication environment is characterized by subscriber requests for multimedia service including high speed data, Video On Demand (VOD) and video conference capability. This causes the service provider to feel a limitation with respect to its capacity, and to construct a broadband communication network using an optical cable.

ADSL is a digital transmission line technology with which high data transmission can be made using the copper cable. Such ADSL is a technology developed by Bellcore in the United States in the 1980's for providing VOD services.

Generally, an ADSL subscriber matching technology can provide only data services using an ADSL line, and a separate frequency band has to be used in order to provide voice services.

Therefore, in order to provide an NGN ADSL subscriber with the voice services on the same line, using the voice frequency, a voice frequency band filter should be connected to the ADSL line. A method for providing the voice service using the ADSL line without the separate voice frequency is divided into Voice over IP (VoIP), Voice over ATM (VoATM) and Channelized Voice over xDSL (CVoDSL). While technology for designing a network embodying the CVoDSL has not been proposed until now, there exist VoIP and VoATM as methods for transmitting the voice data using the same data network with those technologies.

Hereinafter, a voice data transmission on the ADSL subscriber board will be explained. An explanation of the concrete data transmission method will be omitted, and only a portion related to the present invention will be explained.

The apparatus for transmitting voice data on the ADSL subscriber board includes a digital signal processing unit, a storage unit, a digital interface control unit, a modulation/demodulation unit, a signal converting unit, a programmable logic gate, a microprocessor, first, second and third filtering units, and a transceiver. The digital signal processing unit, the storage unit, the digital interface control unit, the modulation/demodulation unit and the signal converting unit are interconnected by an address bus and a data bus, and the signal converting unit and the digital signal processing unit are connected by a serial bus.

The third filtering unit acts as a splitter, which is connected to a Public Switched Telephone Network (PSTN) and performs filtering out of a voice band which is received through a public line. The filtered voice signal is provided to the PSTN, and ATM data remaining after filtering the voice signal is provided to an ADSL modem through the transceiver.

The digital signal processing unit receives the ATM data through a utopia level 2 (UTOPIA 2), performs digital signal processing, and provides the processed data to the modulation/demodulation unit through the data bus.

The modulation/demodulation unit generates (modulates) an ADSL Discrete Multi Tone (DMT) frame signal for the ATM data provided from the digital signal processing unit, and then provides the signal converting unit with the generated ADSL DMT frame signal. Also, the modulation/demodulation unit demodulates the ATM data converted into a digital signal through the signal converting unit, and provides the digital signal processing unit with the demodulated data through the data bus. The modulation/demodulation unit is an ADSL DMT engine.

The frame signal for the ATM data provided from the modulation/demodulation unit is converted into an analog signal in the signal converting unit, filtered through the first filtering unit, and then provided to the transceiver. The first filtering unit may be a high pass filter.

The transceiver transmits signals provided by the first filtering unit through a line driver, a receiver and a signal compensator.

When the voice signal and ATM data are received from the public line, a voice frequency bandwidth of the received data is filtered off through the third filtering unit and the filtered voice signal is transmitted to the exchange through the PSTN. The ATM signal remaining after filtering out of the voice signal is provided to the second filtering unit through the transceiver. That is, using a splitter which performs filtering not of a used frequency band for upload and download of the ADSL, but of bandwidth in order to transmit the voice signal, the ADSL data signal and the voice signal are divided on the same line, and then the line is interconnected and used with the PSTN.

In order to analyze a signal which is transmitted and received through a digital interface control unit using the programmable logic gate, a signal is transmitted and received between the microprocessor and the digital interface control unit using a microbus.

Since the voice signal of the ADSL subscriber uses a different frequency bandwidth, there is no separate unit needed on the ADSL subscriber board. However, external equipment to process the voice signal is needed.

As a result, since the apparatus for transmitting voice data on the ADSL subscriber board has to include a separate splitter for filtering the voice frequency bandwidth rather than the frequency bandwidths of the upload and download of the ADSL used when the voice signal is transmitted, a problem exists in that the system becomes complicated and costs are increased.

Also, since a voice call of only one channel can be accomplished through a pair of telephone lines, there exists a problem in that separate systems have to be added in order that a plurality of users may make calls simultaneously.

### SUMMARY OF THE INVENTION

It is an object of the present invention to provide an apparatus for transmitting voice data on an NGN ADSL subscriber board and a method thereof wherein service to a voice subscriber using an ADSL line is maintained the same with respect to voice quality as to an existing copper cable subscriber, and the same service can be carried out with less expensive construction.

It is another object of the present invention to provide an apparatus for transmitting voice data on an NGN ADSL subscriber board and a method thereof, wherein a splitter which provides services using separate voice band frequency on the ADSL line may be removed, and a plurality of users can be provided with voice services by sharing and dividing a data service frequency band on the same line.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawing in which like reference symbols indicate the same or similar components, wherein:

FIG. 1 is a block diagram of an apparatus for transmitting voice data on an ADSL subscriber board;

FIG. 2 is a block diagram of an apparatus for transmitting voice data on an NGN ADSL subscriber board in accordance with the present invention;

FIG. 3 is a timing chart of an IMDA address latch signal for controlling a digital interface control unit in a microprocessor shown in FIG. 2;

FIG. 4 is a diagram showing control signals which are transmitted and received between the microprocessor and the digital interface control unit shown in FIG. 2;

FIG. 5 is a timing chart of an IDMA long read cycle between the microprocessor and the digital interface control unit shown FIG. 2;

FIG. 6 is a timing chart of an IDMA short write cycle between the microprocessor and the digital interface control unit shown in FIG. 2;

FIG. 7 is a detailed diagram of an exchange match synchronization unit shown in FIG. 2; and

FIG. 8 is a detailed diagram of a time switching unit shown in FIG. 2.

### DETAILED DESCRIPTION OF THE INVENTION

Reference will now be made in detail to exemplary embodiments of the present invention, which are illustrated in the accompanying drawings.

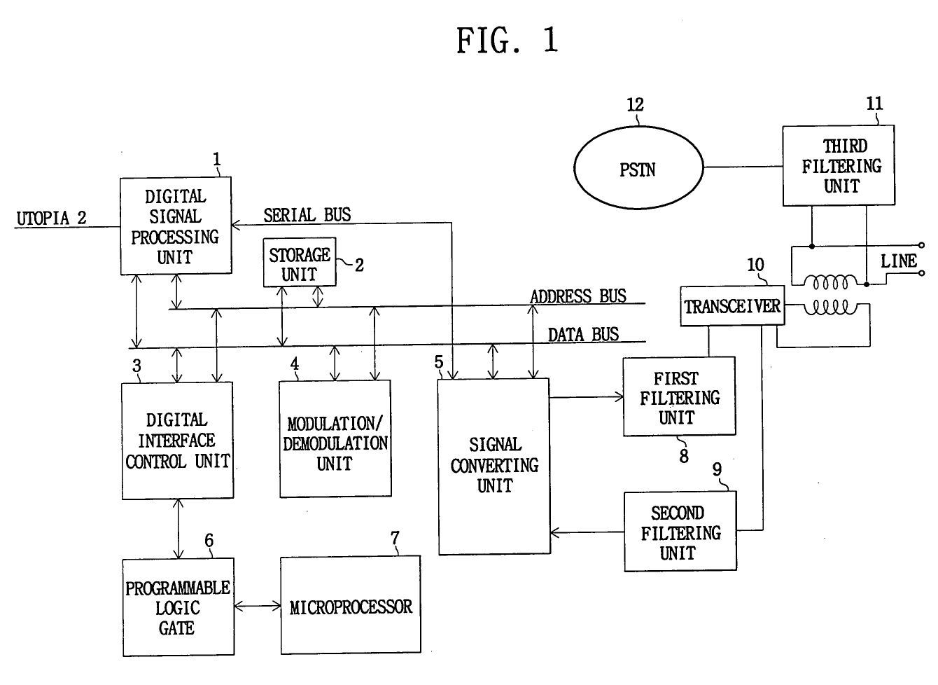

FIG. 1 is a block diagram of an apparatus for transmitting voice data on an ADSL subscriber board.

Referring to FIG. 1, the apparatus for transmitting voice data on the ADSL subscriber board includes a digital signal processing unit 1, a storage unit 2, a digital interface control unit 3, a modulation/demodulation unit 4, a signal converting unit 5, a programmable logic gate 6, a microprocessor 7, first, second and third filtering units 8, 9 and 11, respectively, and a transceiver 10. The digital signal processing unit 1, the storage unit 2, the digital interface control unit 3, the modulation/demodulation unit 4 and the signal converting unit 5 are interconnected by an address bus and a data bus, and the signal converting unit 5 and the digital signal processing unit 1 are connected by a serial bus.

The third filtering unit 11 acts as a splitter which is connected to a Public Switched Telephone Network (PSTN) 12, and which performs filtering out of a voice band which is received through a public line. The filtered voice signal is provided to the PSTN 12, and ATM data remaining after filtering the voice signal is provided to an ADSL modem through the transceiver 10.

The digital signal processing unit 1 receives the ATM data through a utopia level 2 (UTOPIA 2), performs digital signal processing, and provides the processed data to the modulation/demodulation unit 4 through the data bus.

The modulation/demodulation unit 4 generates (modulates) an ADSL DMT frame signal for the ATM data provided by the digital signal processing unit 1, and then provides the signal converting unit 5 with the generated ADSL DMT frame signal. The modulation/demodulation unit 4 demodulates the ATM data converted into a digital signal through the signal converting unit 5, and provides the digital signal processing unit 1 with the demodulated data through the data bus. The modulation/demodulation unit 4 is an ADSL Discrete Multi Tone (DMT) engine.

The frame signal for the ATM data provided by the modulation/demodulation unit 4 is converted into an analog signal in the signal converting unit 5, filtered through the first filtering unit 8, and then provided to the transceiver 10. The first filtering unit 8 may be a high pass filter.

The transceiver 10 transmits signals provided by the first filtering unit 8 through a line driver, a receiver and a signal compensator (not shown).

When the voice signal and ATM data are received from the public line, a voice frequency bandwidth of the received data is filtered off through the third filtering unit 11, and the filtered voice signal is transmitted to the exchange through the PSTN 12. The ATM signal remaining after filtering out the voice signal is provided to the second filtering unit 9 through the transceiver 10. That is, using the splitter 11, which performs filtering not of a used frequency band of upload and download of the ADSL, but of bandwidth in order to transmit the voice signal, the ADSL data signal and the voice signal are divided on the same line, and then the line is interconnected with the PSTN 12.

In order to analyze a signal which is transmitted and received through the digital interface control unit 3 using the programmable logic gate 6, a signal is transmitted and received between the microprocessor 7 and the digital interface control unit 3 using a microbus.

In addition, since the voice signal of the ADSL subscriber uses a different frequency bandwidth, there is no need for a separate unit on the ADSL subscriber board. However, there is a need for additional external equipment in order to process the voice signal.

As a result, since the apparatus for transmitting voice data on the ADSL subscriber board must include a separate splitter for filtering the voice frequency bandwidth rather than the frequency bandwidths of the upload and download of the ADSL used when the voice signal is transmitted, a problem exists in that the system becomes complicated and costs are increased.

Also, since the voice call of only one channel can be accomplished through a pair of telephone lines, there exists a problem in that separate systems need to be added in order that a plurality of users may make calls simultaneously.

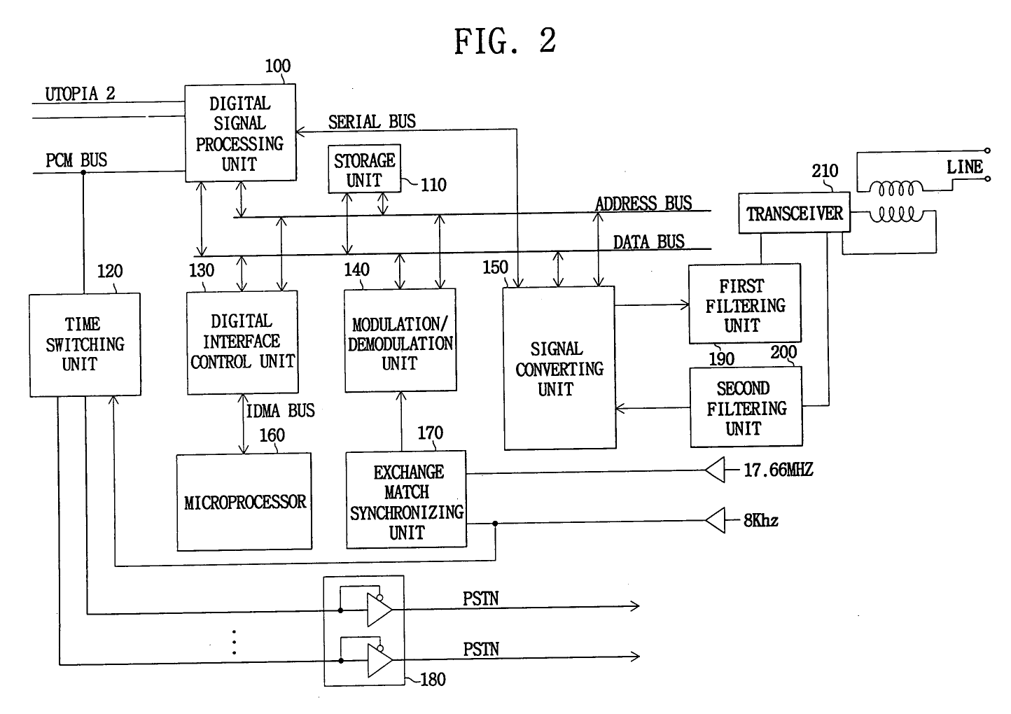

FIG. 2 is a block diagram of an apparatus for transmitting voice data on an NGN ADSL subscriber board in accordance with the present invention. Referring to FIG. 2, the apparatus for transmitting voice data service will be described below but, where components common to FIG. 1 and FIG. 2 exist, the description will be abbreviated.

As shown in FIG. 2, the NGN subscriber board includes an exchange match synchronizing unit 170 which performs same time division of the ATM data with a voice subscriber through a synchronizing communication of the DMT data with a PSTN network in the following manner. A PSTN reference clock and a DMT data clock are generated, and are synchronized. The latter clock signals are provided to modulation/demodulation unit 140 in order to synchronize communication with the PSTN network. A microprocessor 160 analyzes signals transmitted and received to and from a digital interface control unit 130 and the modulation/demodulation unit 140, and controls bus timing with the digital interface control unit 130 using a user programmable memory in order to make accurate transmission and reception of a signal. The digital interface control unit 130 matches the voice data, which are demodulated in the modulation/demodulation unit 140, with an ADSL frame, and provides them to a digital signal processing unit 100. The microprocessor 160 and the digital interface control unit 130 are connected to an IDMA bus in order to perform a CVoDSL function.

In addition, the digital signal processing unit 100 receives ADSL data matched with voice data provided in the digital interface control unit 130, extracts the voice data, and then provides the voice data through a PCM bus to a time switching unit.

The time switching unit 120 selectively outputs the voice data provided by the digital signal processing unit 100 through the PCM bus in order to make it possible to connect the subscriber to each channel.

The PCM bus of each channel is connected to 3-state buffer 180 in order that voice data selectively outputted on each channel through the time switching unit 120 do not interfere and collide with one another, and the microprocessor 160 performs a control function to transmit the voice data to PCM buses of channels different from each other by using the PSTN reference clock and the DMT data clock which are synchronized and provided by the exchange match synchronization unit 170 in order to avoid mutual collisions among the subscriber boards.

The operation of the apparatus for transmitting voice data on the NGN ADSL subscriber board in accordance with the present invention as described above will be explained as follows.

At first, when the voice signal and the ADSL DMT signal are received by transceiver 210 through a public line, the transceiver 210 provides a second filtering unit 200 with the received signals. The second filtering unit 200 performs low pass filtering of the received signals and then provides a signal converting unit 150 with the filtered signals. A distinctive feature of the invention relative to the prior art resides in the fact that, when the voice signal and the ATM signal are received through the public line by a prior art system, a voice frequency bandwidth is filtered through a splitter, the voice signal is provided to the exchange through the PSTN, and the filtered ADSL DMT signal is provided to the transceiver, whereas in the present invention, the voice signal and the ATM signal are directly provided to the transceiver through the splitter without filtering the voice frequency bandwidth.

The signal converting unit 150, shown in FIG. 2, converts the voice and the ADSL DMT signal provided through the second filtering unit 200 into digital signals, and then provides the modulation/demodulation unit 140 with the converted voice and ADSL DMT data through the data bus.

The modulation/demodulation unit 140 demodulates the voice and ADSL DMT frame signals received from the signal converting unit 150 in order that the same time division is obtained between a voice subscriber and the ATM data through a synchronous communication of a PSTN network and DMT data in accordance with the PSTN reference clock and the DMT data clock. The latter two clocks are synchronized and provided by the exchange match synchronization unit 170, and the digital signal processing unit 100 is then provided with the signals through the digital interface control unit 130.

That is, the digital interface control unit 130 matches the voice data demodulated in the modulation/demodulation unit 140 with the ADSL frame, and then provides the digital signal processing unit 100 with the matched data. In addition, a CVoDSL function is performed between the microprocessor 160 and the digital interface control unit 130 through the IDMA bus.

The digital signal processing unit 100 extracts the voice data from data provided through the digital interface control unit 130, and provides a time switching unit 120 with the data through the PCM bus, while the ADSL data are transmitted to the ATM network through a UTOPIA 2 level.

The time switching unit 120 selectively outputs the extracted voice data without mutual interference and collision of the subscribers in each channel. At this point, using the PSTN synchronization clock provided by the exchange match synchronization unit 170 in order to avoid mutual collision among the subscriber boards, the microprocessor 160 controls transmission of the voice data to the PCM buses of channels different with respect to one another.

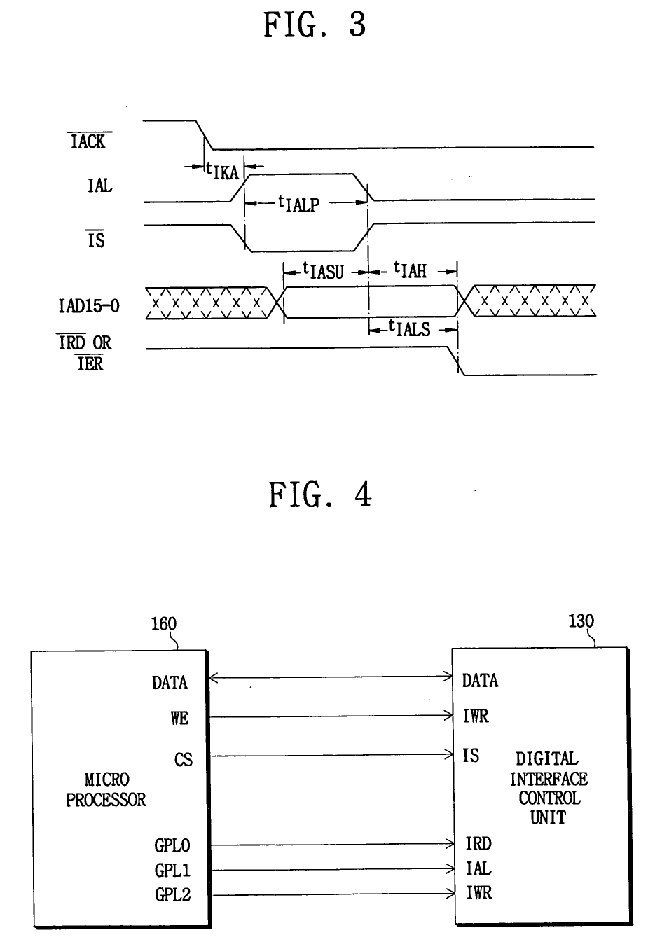

A connection between the digital interface control unit 130 and the microprocessor 160, and control signals transmitted/received between them, will be explained in detail with reference to FIGS. 3 and 4.

FIG. 3 is a timing chart of an IMDA address latch signal for controlling a digital interface control unit in the microprocessor shown in FIG. 2, and FIG. 4 is a block diagram showing control signals transmitted and received between the microprocessor and the digital interface control unit shown in FIG. 2.

The microprocessor 160 and the digital interface control unit 130 are connected to each other by an IDMA bus in order to perform a CVoDSL function, and this connection is an improvement over the method for controlling the microprocessor 7 and the digital interface control unit 3 through the programmable logic gate 6 as shown in FIG. 1.

Parameters for the signals to control the digital interface control unit 130 using the IDMA bus in the microprocessor 160, as shown in FIG. 2, are as follows.

TABLE 1

| PARAMETER | MIN | MAX | UNIT |
|---|---|---|---|
| t_{IALP}: Duration of Address Latch | 10 | | ns |
| t_{IASU}: IAD 15-0 Address Setup before | 5 | | ns |
| Address Latch End | | | |
| t_{IAH}: IAD 15-0 Address Hold after | 2 | | ns |
| Address Latch End | | | |
| t_{IKA}: IACK Low before Start of Address Latch | 0 | | ns |
| t_{IALS}: Start of Write or Read after | 3 | | ns |
| Address Latch End | | | |

The control signal provided by the microprocessor 160 shown in FIG. 2 to the digital interface control unit 130 is an 8-bit parallel signal, and it is possible to transmit the address and data using the 8-bit signal. A latch bus is used in order to transmit the address signal from the microprocessor 160 to the digital interface control unit 130.

Signals which are transmitted and received through a latch bus are shown in FIG. 4. That is, the signals transmitted and received between the microprocessor 160 and the digital interface control unit 130 through the latch bus may include IAD 15-0 which are a 16-bit address and data bus, an IS signal which is a chip selection signal, IRD and IWR signals indicating address read and write, an IAL signal for controlling an address latch function, and an IACK signal which is a signal responsive to the data received by the microprocessor 160. Bus timing for such signals is shown in FIG. 3. That is, FIG. 3 is a view showing the IMDA address latch signal timing provided to control the digital interface control unit 130 in the microprocessor 160 shown in FIG. 2.

In FIGS. 3 and 4, the start of address latch occurs when the IS signal is low and the IAL signal is high, and end of address latch occurs when the IS signal is high or the IAL signal is low. Also, start of write and read occurs when the IS signal, the IWR signal, and the IRD signal are low altogether.

UPM control via a user programmable memory controller of the microprocessor 160 is used to embody the bus, and their connections are shown in FIG. 4.

Referring to FIG.4, control of the digital interface control unit 130 in the microprocessor 160 is obtained when an RAM array of a UPM controller (not shown) in the microprocessor 160 is initiated, and the RAM array is used to control the bus signal using a signal timing generator (not shown) in the microprocessor 160.

Values of the control signals maybe different for each product, and the present invention is intended to stably embody the IDMA address latch function with the digital interface control unit 130 which provides the CVoDSL function by embodying the values.

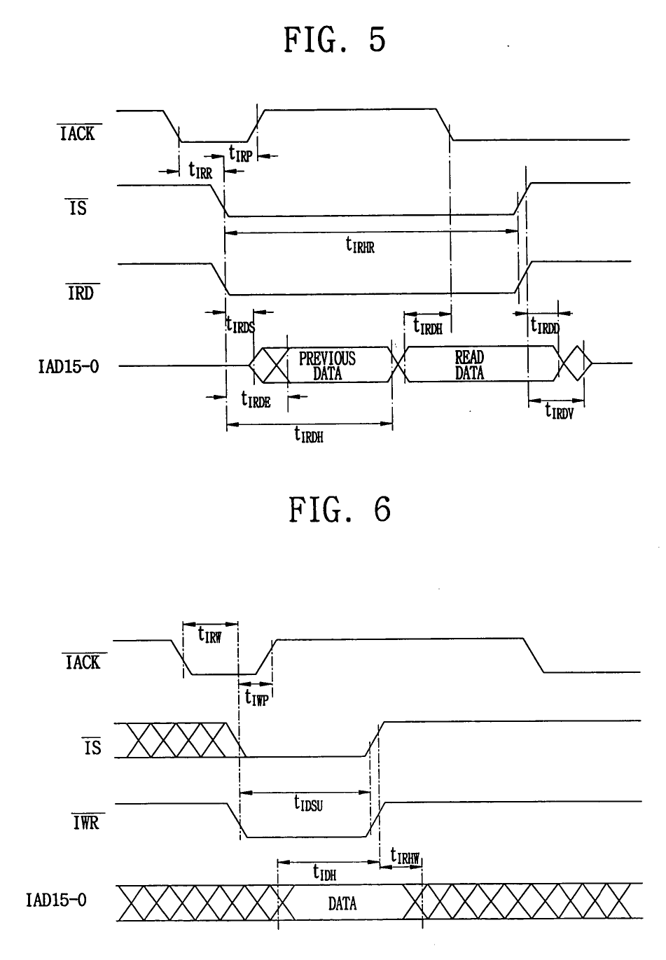

Also, the bus timing for reading data uses a long read cycle bus in order to fetch stable data to the device having a large deviation in the response time, which is a characteristic of the digital signal processing unit 100. Signal parameters in the long read cycle are shown in Table 2, and the timing of the long read cycle is shown in FIG. 5.

FIG. 5 is a timing diagram of an IDMA long read cycle between the microprocessor and the digital interface control unit shown FIG. 2.

TABLE 2

| Parameter(IDMA Read, Long Read Cycle) | Min | Max | Unit |
|---|---|---|---|
| t_{IKR}: IACK Low before Start of Read | 0 | | Ns |
| t_{IRP}: Duration of Read | 15 | | Ns |
| t_{IKHR}: IACK High after Start of Read | | 15 | Ns |
| t_{IKDS}: IAD 15-0 Data Setup before | 0.5t_{ck} - | | Ns |
| IACK Low | 7 | | |
| t_{IKDH}: IAD 15-0 Data Hold after End of Read | 0 | | Ns |
| t_{IKDD}: IAD 15-0 Data Disabled after End of Read | | 10 | Ns |
| t_{IRDE}: IAD 15-0 Previous Data | 0 | | Ns |
| Enabled after start of Read | | | |
| t_{IRDV}: IAD 15-0 Previous Data | | 15 | Ns |
| Valid after start of Read | | | |
| t_{IRDH1}: IAD 15-0 Previous Data Hold after | 2t_{ck} - 5 | | Ns |
| start of Read(DM/PM1) | | | |
| t_{IRDH2}: IAD 15-0 Previous Data | t_{ck} - 5 | | Ns |
| Enabled after start of Read(PM2) | | | |

Start of the data read occurs when the IS signal and IRD signal are low, and end of the data read occurs when the IS and IRD signals are high.

The stable data read in the long read cycle, described in Table 2 and shown in FIG. 5, is advantageous in the case where the times when the data for a read response of the digital signal processing unit 100 are loaded on the buses are different with one another, and where there is no accurate preparation signal for them. Also, it is possible to have rapid transmission using a short data enable signal in the write signal, and FIG. 6 shows that situation. FIG. 6 is a timing diagram of an IDMA short write cycle between the microprocessor and the digital interface control unit 130 shown in FIG. 2, and each signal parameter in the short write cycle timing shown in FIG. 6 is described in Table 3 below.

TABLE 3

| PARAMETER (IDMA Write, Short Write Cycle) | MIN | MAX | UNIT |
|---|---|---|---|
| t_{IRW}: IACK Low before Start of Write | 0 | | ns |
| t_{IWP}: Duration of Write | 15 | | ns |
| t_{IDSU}: IAD 15-0 Data Setup before End of Write | 5 | | ns |
| t_{IDH}: IAD 15-0 Data Hold after End of Write | 2 | | ns |
| t_{IKHW}: Start of Write to IACK HIGH | | | ns |

Start of the data write occurs when the IS and IWR signals are low, and the end of the data read occurs when the IS and IWD signals are high.

Data required for controlling signals shown in the Tables 1, 2 and 3 and FIGS. 4, 5 and 6 are provided by RAM array patterns of the microprocessor 160, and the pattern data are generated using the timing generator (not shown) in the microprocessor 160. The RAM array pattern described above is as follows.

```
  Const ULONG UPMB_TABLE[0x40] = {
  /* long read cycle. (starting with RAM array address 0x00) */
  0x0FAFDC04, 0x0FAFDC04, 0x0FAFDC04, 0x0FAFDC04, 0x0FAFDC04,
0x0FAFDC04, 0x0FAFDC00, 0XFFFFDC07,
  /* burst read. (starting with RAM array address 0x08) */
  0XFFFFFFFF, 0XFFFFFFFF, 0XFFFFFFFF, 0XFFFFFFFF, 0XFFFFFFFF, 0XFFFFFFFF,
0XFFFFFFFF, 0XFFFFFFFF,
  0XFFFFFFFF, 0XFFFFFFFF, 0XFFFFFFFF, 0XFFFFFFFF, 0XFFFFFFFF, 0XFFFFFFFF,
0XFFFFFFFF, 0XFFFFFFFF,
  /* short write cycle. (starting with RAM array address 0x18) */
  0x0FFBec04, 0x0FF4fc04, 0x0FFDcc00, 0xFFFFcc07, 0xFFFFFFFF, 0XFFFFFFFF,
0XFFFFFFFF, 0XFFFFFFFF,
  /* burst write. (starting with RAM array address 0x20) */
  0xFFFFFFFF, 0xFFFFFFFF, 0xFFFFFFFF, 0xFFFFFFFF, 0xFFFFFFFF, 0xFFFFFFFF,
0xFFFFFFFF, 0xFFFFFFFF,
  0xFFFFFFFF, 0xFFFFFFFF, 0xFFFFFFFF, 0xFFFFFFFF, 0xFFFFFFFF, 0xFFFFFFFF,
0xFFFFFFFF, 0xFFFFFFFF,
  /* refresh. (starting with RAM array address 0x30) */
  0xFFFFFFFF, 0xFFFFFFFF, 0xFFFFFFFF, 0xFFFFFFFF, 0xFFFFFFFF, 0xFFFFFFFF,
0xFFFFFFFF, 0xFFFFFFFF,
  0xFFFFFFFF, 0xFFFFFFFF, 0xFFFFFFFF, 0xFFFFFFFF,
  /* exception. (starting with RAM array address 0x3c) */
  0xFFFFCC07, 0xFFFFFFFF, 0xFFFFFFFF, 0xFFFFFFFF
  };
```

That is, the above RAM array pattern may include a long read cycle, burst read, a short write cycle, burst write, refresh and exception patterns, and detailed addresses of each of the patterns are as described above.

In order to transmit a signal synchronized with the PSTN network to the ADSL line using the signaling data controlled by the microprocessor 160, the exchange match synchronization unit 170 shown in FIG. 2 provides a Phase Lock Loop (PLL) clock for controlling timing of the PSTN network, and a local clock for synchronizing the PSTN reference clock and ADSL DMT data clock is used in the exchange match synchronization unit 170 for embodying the present invention. The local clock may be 35.328 MHz.

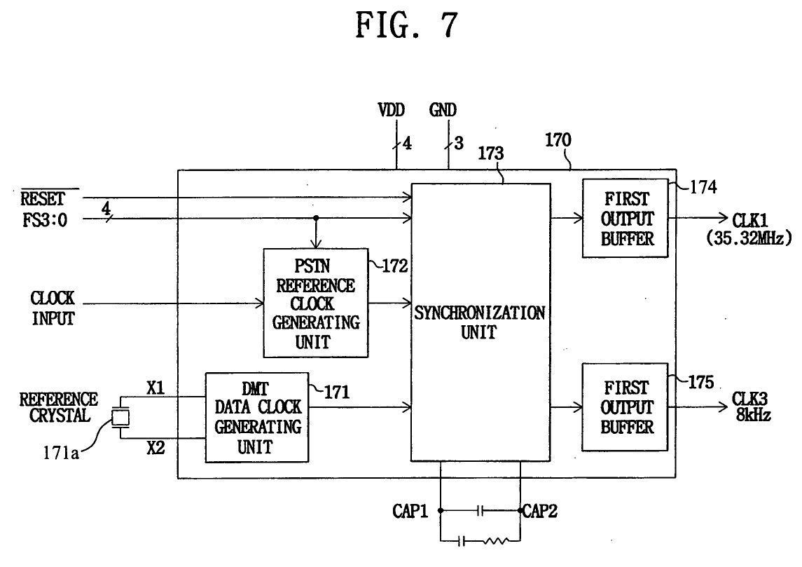

The detailed composition of the exchange match synchronization unit 170, shown in FIG. 2, and its operation will be explained in detail with reference to FIG. 7.

FIG. 7 is a detailed block diagram of the exchange match synchronization unit 170 shown in FIG. 2. The exchange match synchronization unit 170 includes a DMT data clock generating unit 171 for generating a DMT data clock using the clock provided through a reference crystal oscillator 171a, a PSTN reference a clock generating unit 172 for generating a reference clock of the PSTN network, and a synchronization unit 173 for synchronizing the DMT data clock generated in the DMT data clock generating unit 171 and a PSTN reference clock generated in the PSTN reference clock generating unit 172, and for providing the modulation/demodulation unit 140 shown in FIG. 2 with the synchronized DMT data clock and PSTN reference clock through first and second output buffers 174 and 175, respectively. The reference crystal oscillator 171a uses 17.66 MHz, the frequency generated in the DMT data clock generating unit 171 is 35.328 MHz, and the reference clock generated in the PSTN reference clock generating unit 172 is 8 KHz. That is, the DMT data clock CLK1 generated through the first output buffer 174 is 35.328 MHz, and the PSTN reference clock CLK2 outputted through the second output buffer 175 is 8 KHz.

Detailed operation of the exchange match synchronization unit 170 will be explained.

When the reference crystal oscillator 171a shown in FIG. 7 generates 17.66 MHz and provides the DMT data clock generating unit 171 with the generated frequency, the DMT data clock generating unit 171 generates the DMT data clock of 35.328 MHz by oscillating 17.66 MHz, and the generated DMT data clock is provided to the synchronization unit 173.

In addition, the PSTN reference signal generating unit 172 controls a duty cycle in accordance with a logical signal (for example, 110) of an environment control signal which is inputted through [FS 3:0] to the inputted PSTN reference clock 8 KHz, generates the PSTN reference clock, and then provides the synchronization unit 173 with the generated PSTN reference clock.

The synchronization unit 173 synchronizes the clocks provided by the PSTN reference generating unit 172 and the DMT data clock generating unit 171, and outputs the DMT data clock of 35.328 MHz through the first output buffer 174, and the PSTN reference clock of 8 KHz through the second output buffer 175, to the modulation/demodulation unit 140.

As a result, the voice data signal in the ADSL frame is synchronized with the PSTN network, and is transmitted by providing the modulation/demodulation unit 140 with the PSTN reference clock of 8 KHz generated through the PSTN reference clock generating unit 172 and the DMT data clock of 35.328 MHz generated through the DMT data clock generating unit 171.

Accordingly, the modulation/demodulation unit 140 demodulates the voice data and the ADSL frame signal using the synchronized PSTN reference clock and DMT data clock, which are provided by the exchange match synchronization unit 170.

The ADSL frame signal, including the demodulated voice data, is provided to the digital signal processing unit 100 through the digital interface control unit 130.

The digital signal processing unit 100 extracts the voice data from the provided voice data and ADSL frame signal, provides the time switching unit 120 with the voice data through the PCM bus, and transmits the ADSL data to the ATM network through the UTOPIA 2 level.

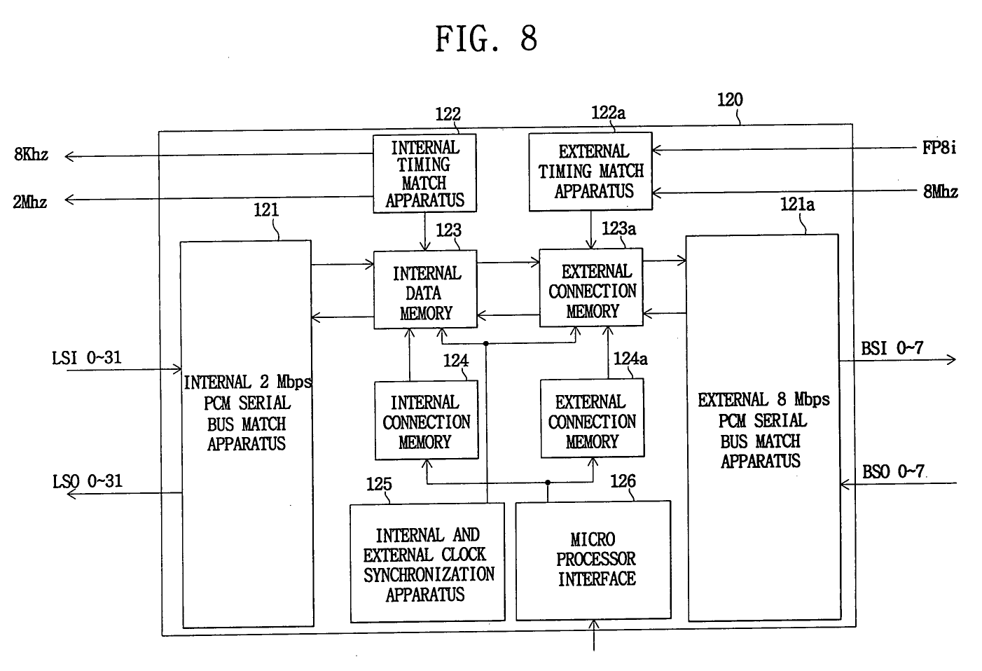

The time switching unit 120 switches the voice data provided by the digital signal processing unit 100 through the PCM bus in each channel, and transmits the data to the PSTN network through the 3-state buffer 180. The time switching operation will be explained in detail with reference to FIG. 8.

FIG. 8 is a detailed block diagram of the time switching unit shown in FIG. 2, and its composition and detailed operation will be explained with reference to the FIG. 8.

Packetized voice data, which are extracted through the digital signal processing unit 100 shown in FIG. 2, are transmitted to a Local Stream Input (referred to as an LSI, hereinafter) shown in FIG. 8, and the signals are transmitted to BSI0-31 by controlling them using an internal connection memory 124. Also, the transmitted signals are transmitted to a Back Plane through the 3-state buffer 180 shown in FIG. 2. The 3-state buffer 180 is used to control a common line bus signal when sharing a PCM serial bus with other ADSL subscriber boards of the NGN system. That is, the design is such as to prevent data collision with other subscriber boards. For a connection operation of the time switching unit 120 through the microprocessor 160, the signal received from the PSTN line of FIG. 2 is transmitted to the BSI0-7 so as to control an external connection memory 124a of FIG. 8 through the microprocessor 160 of FIG. 2, and is then transmitted to the PCM bus of FIG. 5.

Data transmission synchronized with the exchange network is embodied by connecting a PLL_{—}8K signal, outputted through the second output buffer 175 of FIG. 7, to FP8i and performing time division by means of a clock signal synchronized with the PSTN. These clocks are an 8 KHz reference clock of FP8i and an 8 MHz data clock transmit 2 MHz which is synchronized as ¼ frequency division in the external timing match apparatus 122a of FIG. 8 to an internal timing match apparatus 122. The transmitted clocks of 8 KHz and 2 MHz are transmitted to the digital signal processing unit 100 of FIG. 2.

The digital signal processing unit 100 of FIG. 5 sends out the voice data received through the ADSL line by synchronizing the data with the clocks through the PCM serial bus among the LSI0-31 of FIG. 8, and transmits the data to the internal data memory through an internal 2 Mbps PCM serial bus match apparatus 121 of FIG. 8. The transmitted voice data serve to control the internal connection memory 124 through a microprocessor interface 126, and to make a time slot position, that is, a channel position to be determined when the voice signal inputted to the LSI0-31 is transmitted to the BSO0-7. In order to match the 8 Mbps PCM bus of the back plane, a rate adaption function is embodied using a clock of an external timing transmission block in the course of transmitting to an internal data memory 123 and an external data memory 123a. That is, the voice data of the NGN subscriber board are clearly transmitted through the 8 Mbps PCM serial bus of the external back plane using the time switching function of FIG. 8.

As a result, the CVoDSL function provided in accordance with the present invention can simultaneously perform voice and data services with existing PSTN network interconnected through the DSL based on an ATM, a frame relay and an IP.

Such a CVoDSL function provides a signal transmission channel of wide band through the telephone line already in existence. While the existing telephone uses a voice call channel through a pair of telephone lines, the CVoDSL in accordance with the present invention can make use of call and data services of tens of channels simultaneously and cheaply, using the existing copper cable. That is, a plurality of voice subscribers can be serviced with the same voice quality as provided to the existing PSTN subscriber through the ADSL line, and simultaneously. Also, a separate system, such as a voice gate, is not needed. This technology can be embodied in an NGN system which is interconnected with the PSTN network, and its function is carried out on the subscriber board.

Although preferred embodiments of the present invention have been described, it will be understood by those skilled in the art that the present invention should not be limited to the described preferred embodiments. Rather, various changes and modifications can be made within the spirit and scope of the present invention, as defined by the following claims.

What is claimed is:

1. An apparatus for transmitting voice data on a Next Generation Network Asymmetric Digital Subscriber Line (ADSL) subscriber board, said apparatus comprising:
demodulating means responsive to reception of voice and ADSL data for demodulating the received voice and ADSL data, and for synchronizing the demodulated voice data in an ADSL frame signal so as to output the voice data in accordance with a synchronization clock signal provided to said demodulating means;
synchronizing means for synchronizing a Public Switched Telephone Network (PSTN) reference clock and an ADSL Discrete Multi Tone (DMT) data clock to provide the synchronization clock signal to the demodulating means;
data extracting means for extracting the voice data in the ADSL frame data outputted from said demodulating means, and for outputting the extracted voice data and the ADSL frame data; and
switching means for selectively outputting the extracted voice data, outputted by said data extracting means, to the PSTN through a plurality of assigned channels.

2. The apparatus according to claim 1, wherein the voice data extracted by said data extracting means are outputted to said switching means through a PCM bus, and the ADSL frame data are outputted to an Asynchronous Transfer Mode (ATM) network as ATM data of a UTOPIA 2 type.

3. The apparatus according to claim 1, wherein said synchronizing means comprises:
a DMT data clock generating unit for generating a DMT data clock using a clock provided by a reference crystal oscillator;
a PSTN reference clock generating unit for generating a reference clock of the PSTN; and
a synchronizing unit for synchronizing the DMT data clock generated by the DMT data clock generating unit and the reference clock of the PSTN generated by the PSTN reference clock generating unit, and for providing the synchronized DMT data clock and the synchronized PSTN reference clock to said demodulating means through respective output buffers.

4. The apparatus according to claim 3, wherein a clock frequency provided by the reference crystal oscillator in the DMT clock generating unit is 17.66 MHz.

5. The apparatus according to claim 3, wherein the DMT data clock frequency generated by the DMT data clock generating unit is 35.328 MHz, and a reference clock frequency generated by the PSTN reference clock generating unit is 8 KHz.

6. The apparatus according to claim 3, wherein the synchronizing unit comprises a Phase Lock Loop.

7. The apparatus according to claim 1, further comprising:
digital interfacing means for matching the voice data demodulated by said demodulating means with an ADSL frame in accordance with a plurality of Channellized Voice over xDSL (CVoDSL) control signals provided to perform a CVoDSL function, and for interfacing the data with said data extracting means; and
control means for providing the plurality of CVoDSL control signals to the digital interfacing means through an arbitrary bus.

8. The apparatus according to claim 7, wherein the CVoDSL control signals provided by said control means to said digital interfacing means are provided through an IDMA bus.

9. The apparatus according to claim 8, wherein the CVoDSL control signals provided by said control means to said digital interfacing means through the IDMA bus include an IAD comprising address and data signals, an IS signal comprising a chip selection signal, IRD and IWR signals indicating address reading and writing, an IAL signal for controlling an address latch function, and an IACK signal comprising a response signal generated in response to the data received from said control means.

10. The apparatus according to claim 7, wherein said control means includes a signal timing generator for generating an RAM array pattern in order to control the CVoDSL control signals provided to said digital interfacing means.

11. The apparatus according to claim 10, wherein the RAM array pattern comprises a long read cycle, a burst read, a short write cycle, a burst write, a refresh and exception patterns.

12. The apparatus according to claim 1, further comprising at lease one three-phase buffer for buffering the voice data of each channel in order that the voice data, connected to a plurality of channels of said switching means and outputted through the plurality of channels, are outputted to the Public Switched Telephone Network through each channel without any collision and without interference between each said subscriber board.

13. A method for transmitting voice data on a Next Generation Network Asymmetric Digital Subscriber Line (ADSL) subscriber board, the method comprising the steps of:
receiving voice and ADSL data;
demodulating the received voice and ADSL data;
synchronizing the demodulated voice data in an ADSL frame signal in accordance with a predetermined synchronizing clock signal;
extracting the synchronized voice data in the ADSL frame signal, and outputting each of the extracted voice data and the ADSL frame data through buses; and
selectively outputting the voice data outputted through the buses to a Public Switched Telephone Network (PSTN) through a plurality of assigned channels.

14. The method according to claim 13, wherein the extracted voice data are outputted through a PCM bus, and the ADSL frame data are outputted to an Asynchronous Transfer Mode (ATM) network as ATM data of a UTOPIA 2 type.

15. The method according to claim 13, wherein the synchronizing step comprises sub-steps of:
generating a Discrete Multi Tone (DMT) data clock using a clock which is provided through a reference crystal oscillator;
generating a reference clock for the PSTN; and
synchronizing the generated DMT data clock and the generated reference clock for the PSTN; and
synchronizing the demodulated voice data in the ADSL frame signal using the synchronized DMT data clock and the synchronized PSTN reference clock.

16. The method according to claim 13, further comprising the step of matching the demodulated voice data with an ADSL frame in accordance with a plurality of Channelized Voice over xDSL (CVoDSL) control signals provided to perform a CVoDSL function.

17. The method according to claim 16, wherein the CVoDSL control signals include an IAD comprising address and data signals, an IS signal comprising a chip selection signal, IRD and IWR signals indicating address reading and writing, an IAL signal for controlling an address latch function, and an IACK signal comprising a response signal generated in response to the data received from said control means.
